(19) United States
(12) Patent Application Publication
(10) Pub. No.: US 2004/0123184 A1
(43) Pub. Date: Jun. 24, 2004

(54) System and method of facilitating communication

(76) Inventor: Andrew M. Westberg, Peoria, IL (US)

Correspondence Address: CATERPILLAR INC., 100 N.E. ADAMS STREET, PATENT DEPT., PEORIA, IL, 616296490

(21) Appl. No.: 10/325,502

(22) Filed: Dec. 19, 2002

(51) Int. Cl. G06F 11/00

(52) U.S. Cl. 714/38

(57) ABSTRACT

The present disclosure include a method and system configured to facilitate communication in a computing system having multiple applications communicating through a software communication conduit. The method may include the steps of detecting a failed communication between a first and second application, establishing a cause of the failed communication, and causing the communication to be re-transmitted.

### TECHNICAL FIELD

This invention relates generally to a method and system of facilitating communication, and more particularly, to a method and system of facilitating communication in a computer system having multiple applications communicating through a software communications conduit.

### BACKGROUND

Current and future business computing solutions involve may applications communicating with each other through a network. The applications may vary in type, such as financial applications and inventory management applications. In addition the applications may have been developed by different vendors. Therefore, when one application sends information to another application, rarely are the communication formats, e.g., data structures, compatible. There are tools, and communication protocols, that exist today that attempt to minimize the incompatibilities. For example, communication standards attempt to ensure that any application communicating in a particular environment do so using the same standard format. Existing tools go a step further and attempt to be a repository of application communication interfaces. Therefore, if application A, having interface X, is communicating with application B, having interface Y, the tool would receive application A's communication, convert it to interface Y, and then deliver it to application B. However, due to the volume of transactions, the number of different types of applications, the number of different types of vendors etc, communication errors still occur. Some current systems attempt to resolve the communication error by establishing that an error associated with a particular communication occurred, and then simply delivering the desired communication to the second application. For example, some tools may enable a user to manually view the communication that failed, modify the data such that the data will be accepted by the receiving application, and then deliver the modified data to the receiving application. However, the integrity of the data has been reduced. That is, the modified data residing in the receiving application may not be what was intended by the sending application. In a system having a large number of communications, data inconsistencies can cause serious problems, e.g., to the applications, to the system, and also from a data auditing perspective.

The present disclosure is directed to overcoming one or more of the problems set forth above.

### SUMMARY OF THE INVENTION

In one aspect of the present invention, a method of communicating in a computing system having multiple applications communicating through a software communication conduit is disclosed. The method includes the steps of detecting a failed communication from a first application intended for a second application, establishing a cause of the failed communication; and causing the communication to be re-transmitted from the first application.

### BRIEF DESCRIPTION OF THE DRAWINGS

FIG. 1 is an illustration of one embodiment of a computing system having multiple applications communicating through a software communication conduit;

FIG. 2 is an illustration of two exemplary data structures;

FIG. 3 is an illustration one embodiment of a method of communicating in a computing system;

FIG. 4 is an illustration of a system configured to facilitate communication in a computing system;

FIG. 5 is an illustration of one embodiment of a display associated with communication failures;

FIG. 6 is an illustration of one embodiment of a display associated with communication failures;

FIG. 7 is an illustration of one embodiment, of a display associated with communication failures;

FIG. 8 is an illustration of an embodiment of a display associated with communication failures;

FIG. 9 is an illustration of one embodiment, of a display associated with communication failures; and

FIG. 10 is another illustration of an embodiment of a display associated with communication failures.

### DETAILED DESCRIPTION

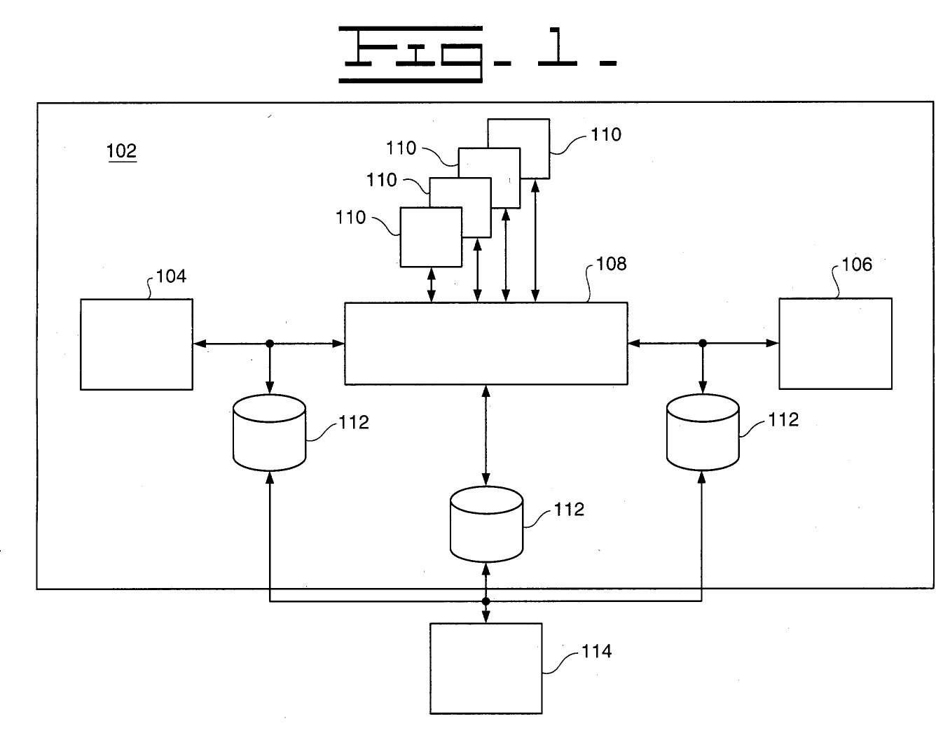

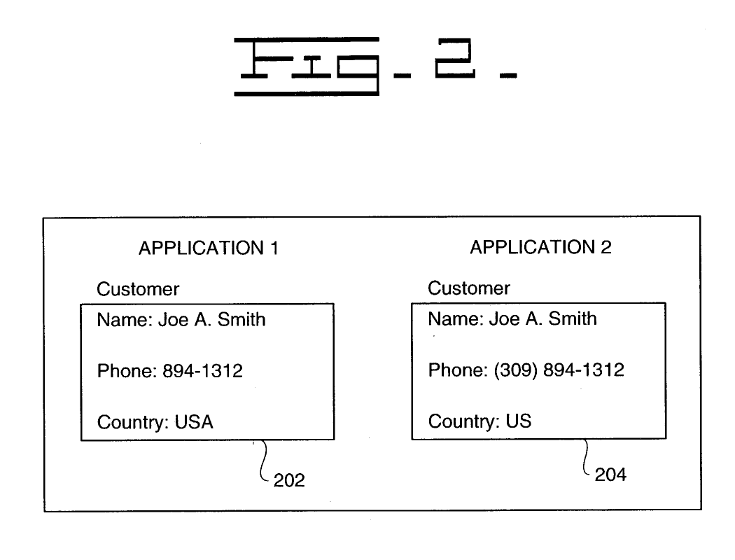

The present disclosure is associated with a method and system of communicating in a computing system having multiple applications. FIG. 1 illustrates one embodiment of a computing system 102 associated with the present invention. The computing system 102 may include a first application 104 communicating with a second application 106, through a software communication conduit 108. The computing system 102 may include other applications 110 communicating with each other or with the first and second applications 104, 106. The applications may be of the same or different types. For example, types of applications may include financial, accounting, inventory management, sales etc., or any other type of function that a business or individual is involved in. The applications may be of the same or different vendors. The software communication conduit 108 may be a conduit that facilitates communication between applications. The communication conduit 108 may facilitate communication in many different ways, and the specific features and functions of the communication conduit 108 are implementation dependent. In one embodiment, for exemplary purposes only, the conduit 108 may facilitate communication among applications having different interfaces, e.g., due to different application types, different vendors, and/or different communication protocols. The communication conduit 108 may be configured to receive a communication from the first application 104, the communication having a first data structure, modify the first data and/or data structure to be compatible with a second application, and then deliver the communication (having the modified data structure) to the second application. In one embodiment, the communication conduit 108 may establish the data structures of the different types and/or vendors of applications. In this manner, when a communication is received, the conduit 108 may compare the data structures of the sending and receiving applications, and modify the data and/or data structure included in the communication to be compatible with the receiving application (e.g., the second application 106).

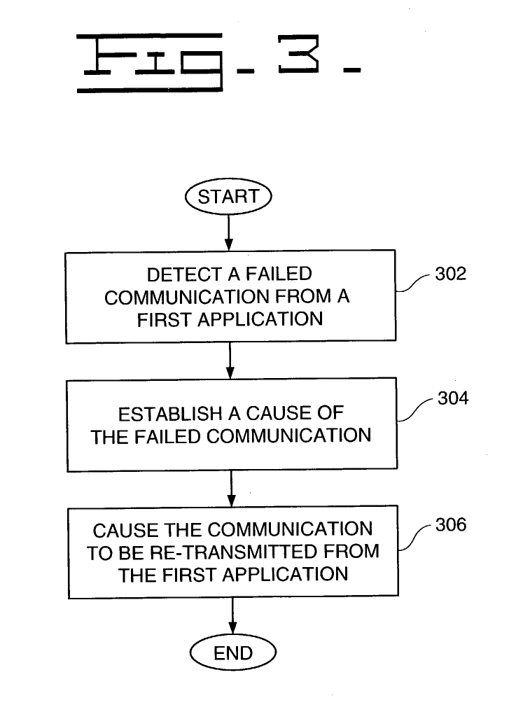

A simplistic example of data structures is provided in FIG. 2. The first data structure 202 (associated with a first application), may have fields for name, phone number, and country. The second data structure 204 (associated with a second application), may have the same fields for name, phone number, and country. In the example shown, the phone number field associated with the first data structure 202 may not include an area code, whereas, the phone number field associated with the second data structure 204 may include an area code. In addition, the country field in the first data structure 202 may be configured for a three digit country code, whereas the country field in the second data structure 204 may be configured for a two digit country code. In one embodiment, the communication conduit 108 may receive a communication from the first application having the first data structure 202. The conduit 108 may compare the received data structure with that of the second application from the second data structure 204 associated with the second application. In one embodiment, based on the second customer data structure 204 of the second application, the conduit 108 may modify the country data received to be compatible with the country data field of the second application (e.g., the conduit 108 has data structures and/or look up tables that enable it to convert the three digit country code USA into the two digit country code US). The modified communication may then be delivered to the second application. In an alternative embodiment, the data associated with the first data structure 202 (e.g., the country) may be deemed to be incompatible with the data structure 204 associated with the second application and the communication would fail. For example, the conduit 108 may be configured to manipulate two digit country codes (i.e., the conduit expects that both applications use a two digit country code). Therefore, when the three digit code is received from the first application, the conduit 108 does not know how to translate it, and therefore places it in a failure bin (discussed below). Expanding on the example illustrated in FIG. 2, the data structure of the second application 204 may expect an area code associated with the phone number. If the area code is not included in the communication from the first application, the conduit 108 may deem the communication to be incompatible with the data structure 204 of the second application, and the communication would fail.

In one embodiment the communication conduit 108 establishes the appropriate data structures associated with the applications by storing the data structures in memory, e.g., in advance of the communication, and then accessing them when needed. In one embodiment, the data structures may be dynamically determined. For example, when a new application has been connected to the conduit 108, there may not be prior knowledge of the data structure associated with that application. Therefore, conduit 108 may access the application, interrogate the application about its data structures, and then store the received data structures in the database for future reference. The above is merely an example of how a communication conduit 108 may function, and how communication errors may occur, and is not intended to limit the scope of the present invention.

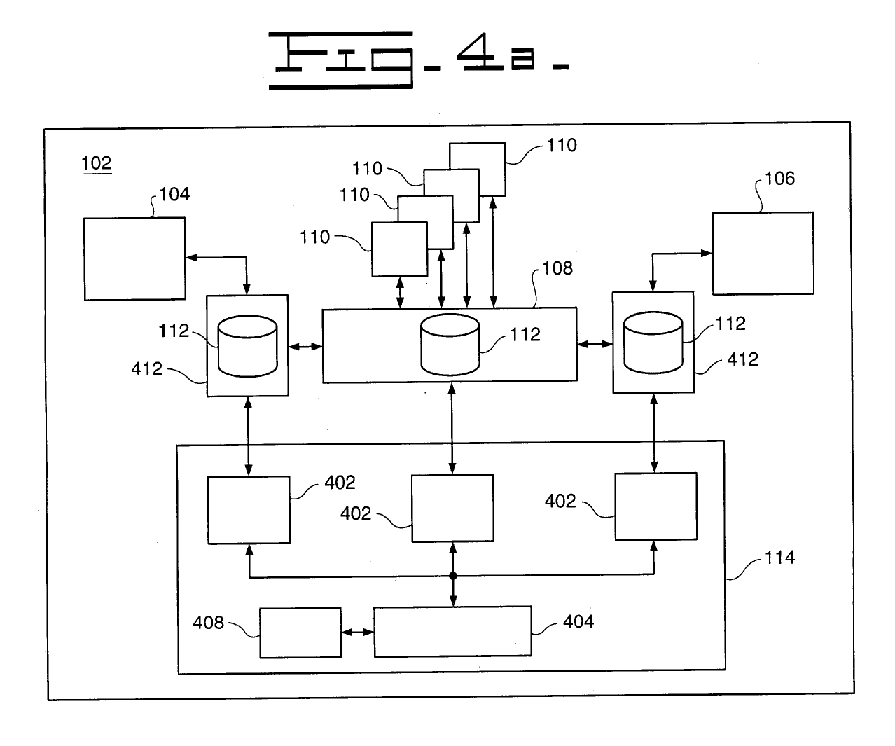

FIG. 3 illustrates one embodiment of a method of communicating in a computing system 102 having multiple applications, where the applications communicate through a communications conduit 108. In a first control block 302 a failed communication from a first application to a second application is detected. In one embodiment, a computing system 102 may have one or more failure bins 112, where communication failures are stored or logged. Failure bins 112 may also be referred to as event queues. For example, regardless of where a communication failure occurs, or why it occurs, the communication and/or information associated with the communication is stored in the failure bin 112 when the communication fails. In one embodiment, the detection of a failure occurs by monitoring the failure bin 112. The bin monitoring may occur either automatically or manually. For example, a communication facilitation system 114 may include an algorithm that monitors the failure bins 112. The rate at which the failure bin 112 is monitored is implementation dependent. For example the monitoring rate may be at a predetermined frequency, frequency based on communication activity associated with the conduit 108, and/or upon user request. When information is stored on the failure bin 112 then a notification may be sent to a user indicating a failure has occurred. Alternatively, a user may manually access the failure bin 112 and/or information associated with the failure bin, e.g., via the facilitation system 114, and determine if a failure occurred. For example, the facilitation system 114 may include a web based interface that enables a user to access information associated with the communication failures. The facilitation system 114 may access the bins 112, establish whether a communication failure has occurred, sort the failure into a category based on type of failure or the vendor/application associated with the failure, and then provide the information to the user through the web based interface. As will be described later, in one embodiment, the process may be automated such that a user does not interact with the computer system 102 when a failure occurs. For example, when a communication is being prepared to pass from the first application to the conduit 108, a failure may occur for reasons such as the hardware associated with the communication medium is down, or there is a problem with the communication (e.g., data or format). When the computer system 102 realizes the hardware is down, or the communication has a format problem etc., the communication may be placed on a failure bin 112. In one embodiment, determining the hardware is down, or the communication has a format problem etc, may be considered detecting a failed communication. Alternatively, detecting a communication failure may include monitoring the failure bin 112 by the facilitation system 114, to determine when a communication event has been placed on the queue.

In a second control block 304, the cause of the failed communication may be established. In one embodiment, establishing the cause of failure may include establishing a failure characteristic associated with the communication, and determining the cause of failure in response to the failure characteristic. In one embodiment, a failed communication may include a characteristic associated with the failure. The failure characteristic may pertain to the hardware associated with the computer system 102 not being functional, the communication format (e.g., data or underlying structure) not be acceptable, etc. In one embodiment, as mentioned, the facilitation system 114 may monitor the failure bins 112 to establish a failure has occurred, and to determine the cause of the failure. The communication failure may then be sorted by time of failure, type of failure (e.g., the failure characteristic), and/or the application/vendor associated with the failure. There may be a category associated with failures resulting from hardware problems, e.g., the hardware associated with the conduit 108 is not functioning. Therefore, establishing a cause of failure may include detecting a failed communication in a failed hardware bin 112, and analyzing the failure characteristic associated with the failure, e.g., that the hardware associated with the conduit 108 was down. In one embodiment, the analysis of the communication and/or failure characteristic may be automatically performed by the facilitation system 114. Alternatively, a user may access a particular category included in the facilitation system 114, that is associated with the failure bins 112, and analyze the communication manually to determine the cause of the failure. For example, a user may access a failed communication, and analyze the data and/or data structure associated with the first application, and the expected data and/or data structure of the second application, thereby establishing the cause of the failure. For example, as illustrated in FIG. 1, the user may recognize that first application was sending a three digit code, while the second application was expecting a two digit code.

In one embodiment, the cause of the failure may be established by the algorithm placing the communication in the failure bin 112. For example, the communication software may recognize why the failure occurred, e.g., the hardware associated with the conduit 108 would not respond, or would not access a communication queue, and therefore the communication software may place the communication in the failure bin 112, and also log the associated failure characteristic, e.g., hardware not responding.

In one embodiment the system 114 may access the failure bins 112 and sort the communication failures into categories (e.g., user designated categories) accordingly. The specific categories included in the facilitation system 114 is implementation dependent, and application dependent. That is, as is explained below, the category, headings in a category, and contents within a category may vary from one application and/or vendor to another and may be based upon the communications transmitted and/or received, the type of data and/or data structure, and the type of applications etc. For example, a category may be associated with the location in the system 102 in which the failure occurred (e.g., prior to reaching the communication conduit 108, within the conduit 108, or as the communication is being delivered to the receiving application). In addition, the communication may be categorized, based upon the type of application sending and/or receiving the communication. For example, if an accounting application is sending a communication to an inventory application, the failed communication may categorized with the heading of accounting-to-inventory. In addition, the heading of the failed communication may include the type of data being communicated, e.g., customer-data.

In a third control block 306, the communication may be retransmitted from the first application. In one embodiment, the communication may be modified in response to the established cause of failure. For example, if it is determined that a data problem was the issue, then the communication may be fixed by fixing the data associated with the communication, and then causing the first application to retransmit the communication. For example, a user may create a purchase order, in a first application 104. The user enters data into the “State” field, which expects a two digit code. However, the user enters LL instead of IL. In this example, application 1 is satisfied because a two digit code has been entered, and therefore it sends the communication, including the data associated with the purchase order, to the software conduit 108. The software conduit 108 determines the second application 106 is expecting a two digit unabbreviated state name. Therefore, the conduit 108 attempts to translate LL into an unabbreviated name of a state, as is expected by the second application 106. However, LL is not listed in a data table, as a valid, or expected, abbreviation, and therefore the software conduit 108 is unable to translate the data, and places the communication in a failure bin 112. The facilitation system 114 establishes a communication has failed by monitoring the failure bin 112, establishes a cause of the failure, and enables a user to view the communication and associated data. The user may then review the data and determine the abbreviation LL is not a valid state abbreviation, and that the abbreviation should have been IL. Then the user may access the data structure associated with the first application, e.g., access the purchase order that was created, modify the data (e.g., type IL into the purchase order), and then cause the data to be retransmitted. In one embodiment, the computer system 102 has event queues associated with communication flow. The event queues may be included with, or located in the failure bins 112, or associated with the application(s) and or communication conduit 108. The event queues may maintain information regarding the status of a communication, and the communication itself, or an address where the data associated with the communication is stored in the application. For example, the event queues may contain a status of pending or previously transmitted messages. The status may include: Pending, Failed, Completed. An event queue associated with the first application may have an entry for Purchase Order #7 (i.e., the communication associated with the created purchase order). The entry associated with the Purchase Order #7 may indicate “C” for completed. However, the event queue associated with the conduit 108 may have an entry associated with the Purchase Order #7 that may indicate “E” for error. This may be because from the perspective of the first application 104, the communication was successfully sent, however, from the perspective of the conduit 108, there was a communication failure. The first application 104, or some form of communication software may monitor the event queues to determine if any action is needed (e.g., there is a communication that is pending). Therefore, upon establishing a failure occurred establishing the cause of the failure, and modifying the data if appropriate, the facilitation system may cause the communication to be retransmitted. The manner in which the communication is implementation and application dependent. For example, the facilitation system 114 may modify the status of the communication in the event queue associated with the purchase order, from Completed, to Pending. The first application 104, or associated communication software, will detect the communication is pending, and then send the communication to the software conduit 108. For example, the event queue may access the data from a memory address within the application, and then send the communication and associated data to the software conduit 108. When the communication conduit 108 receives the communication, it is able to translate IL into Illinois for the second application, and pass an appropriate communication on to the second application. Therefore, both the first and second application have consistent data.

In one embodiment, if the failure was caused by a technical problem, e.g., the hardware associated with the conduit 108 was down, the communication status may merely be changed from failed or completed, to pending, in order to be re-sent from the first application to the second application, once the hardware is functioning again.

In one embodiment, the cause of the failed communication and the re-transmission of the message may occur automatically. For example, if the communication failure was caused by a hardware problem, then facilitation system 114 may access the failure bin 112, establish the failure was hardware related, determine if the hardware is functioning now, and then cause the retransmission of the communication (e.g., change the status of the communication in the event queue), without the intervention of a user.

Alternatively, a user may oversee this activity.

### Inudstrial Applicability

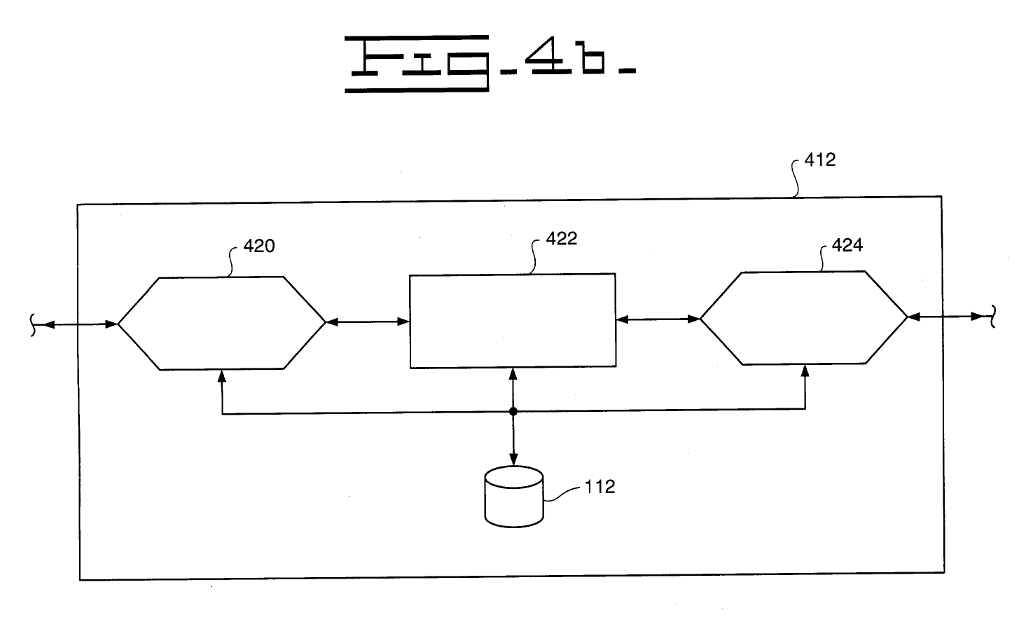

The present disclosure includes a method and facilitation system 114 configured to facilitate communication in a computing system 102 having multiple applications communicating through a software conduit 110. The method may include the steps of detecting a failed communication between a first and second application, establishing a cause of the failed communication, and causing the communication to be re-transmitted. In one embodiment, the computing system 102 may include a communication conduit 108, and one or more communication queues 412, to facilitate the transmission/reception of communication messages between the applications 104, 106, 110, and the communication conduit 108, as illustrated in FIG. 4A. FIG. 4B illustrates one embodiment of a communication queue 412. The communication queue may include an event queue and/or failure bin 112. The failure bin may include the event queue. The communication queue 412 may include a connection agent 420 that reviews an event table or event queue associated with an application. If there is a communication failure the connection agent 420 may place the error in a failure bin 112. The communication queue 412 may also include a queuing function 422 that enables the queuing of communications prior to sending them to the software conduit 108. For example if an application is sending multiple communications, or multiple applications are interfacing to the communication conduit 108 through a common interface, the queuing function may assist coordinating the transfer of the communications to the software conduit 108. In one embodiment the communication queue 412 may also include a connector controller 424 that is responsible for delivering the communication to the software conduit 108. The failure bin 112 may be included on one or more of the connection agent 420, the queuing function 422, and/or the connector controller 424. In one embodiment the communication queue 412 may include a failure bin 112. In one embodiment, the facilitation system 114 may include a facilitation algorithm 404. In one embodiment, the facilitation system 114 may also include a user interface 408

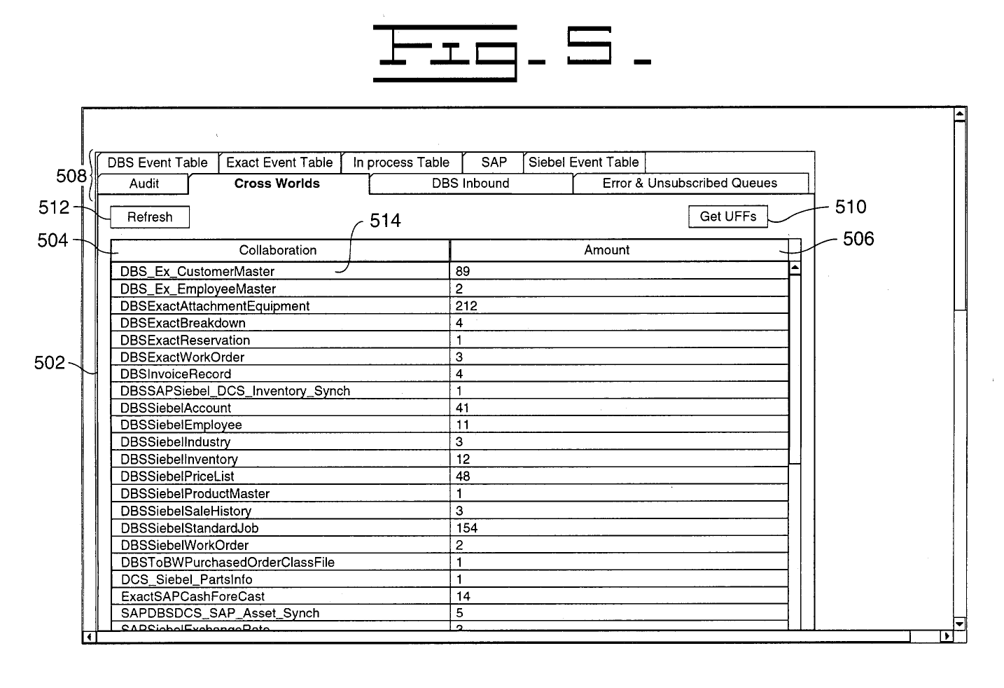

In one embodiment, the facilitation system 114 is a web based tool that a user may access, e.g., via the web based user interface 408. The user may login to the system 406 and access information associated with one or more of the failure bins 112. The system 114 may access the failure bins 112, establish that a failure occurred, establish the cause of the failure, and sort the failure into a category 402 accessible by a user. For example, the user may be presented with a display 502 that has categories associated, as illustrated in FIG. 5. In one embodiment, the categories may be established based on the vendor providing the software, and/or the associated application of the vendor, i.e., a vendor may have multiple application packages associated with the computing system 102. In the illustrated embodiment, each application (e.g., Exact, Inprocess, SAP, Siebel, Crossworlds, DBS), may have an associated category. Therefore, when a communication failure occurs, either as the communication is being delivered to the conduit 108, being delivered from the conduit 108, and being processed by the conduit 108, the failed communication is placed in the designated category 402. In one embodiment, the communication failure may be referred to as an unfinished flow. Therefore, a user may select which vendor, or application to view. For example, by selecting one of the vendor and/or application tabs 508 the user may view the associated information. For example a user may access information associated with the category 402 associated with the conduit 108, which in this example is CrossWorlds. The information may include a category of failure, or collaboration 504. For example, the collaboration DBS_Ex[Exact]_CustomerMaster 514 indicates that at least one failure occurred on a communication from the application DBS (e.g., the first application 104), and Exact (e.g., the second application 106), and that the application or function associated with the failed communication was the DBS function Reservation. In addition, the amount 506 indicates the number of these types of failures that are currently unresolved. Alternatively the amount may indicate the total number of failures since a designated point in time. Logging the number of failures associated with one or more applications or vendors assist the user in diagnosing the cause, and also to establish a resolution. For example, a high number of failures between two applications may either mean that there was a lengthy hardware problem associated with the system 102, or that the data and/or data structures between two applications (or vendors) currently has some incompatibilities, meaning the data structures of the two applications should be reviewed to establish either how to translate data from one application to the other, or how to modify the data structures so that they are now compatible.

In one embodiment, the collaboration category 504 may also indicate that the failure was associated with the communication queue 412, e.g., DBSMQSeries2Connector (420). In one embodiment, the interface 502 will also enable the user to refresh the information (refresh button 512). When the refresh button 512 is selected, the facilitation system 114 updates the information with any new failures and/or removes any resolved failures from the failure bin 112. In one embodiment, failure bins 112 may be monitored at a predetermined frequency, and/or predetermined time of day etc., or upon a user request. In one embodiment, the user may also view all of the communication failures, or unfinished flows (Get UFF button 510).

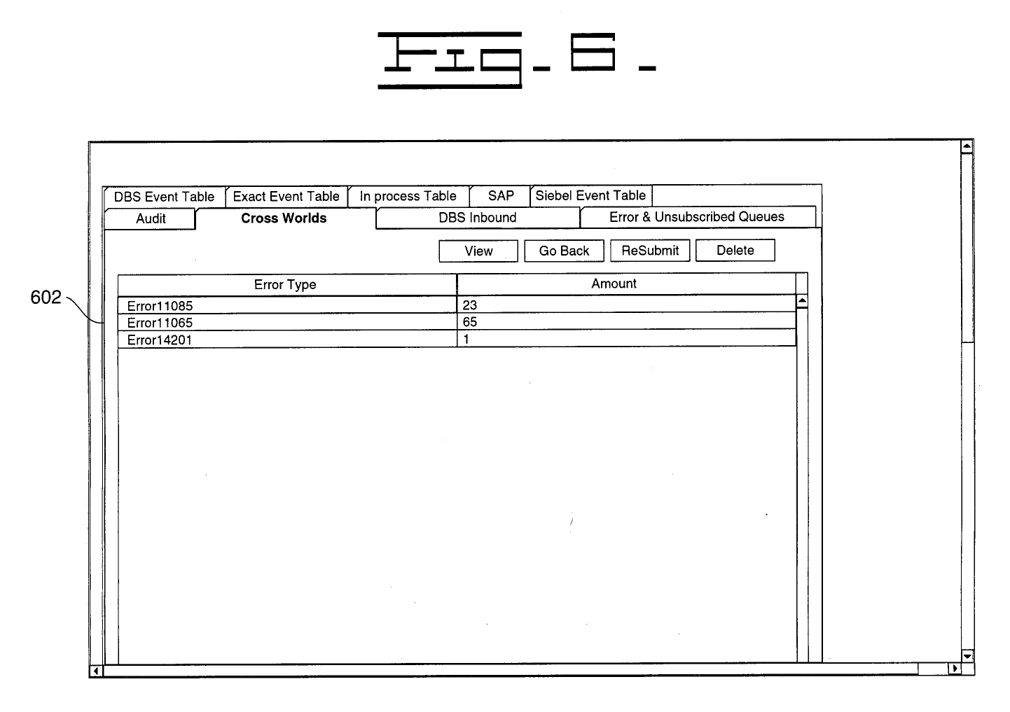

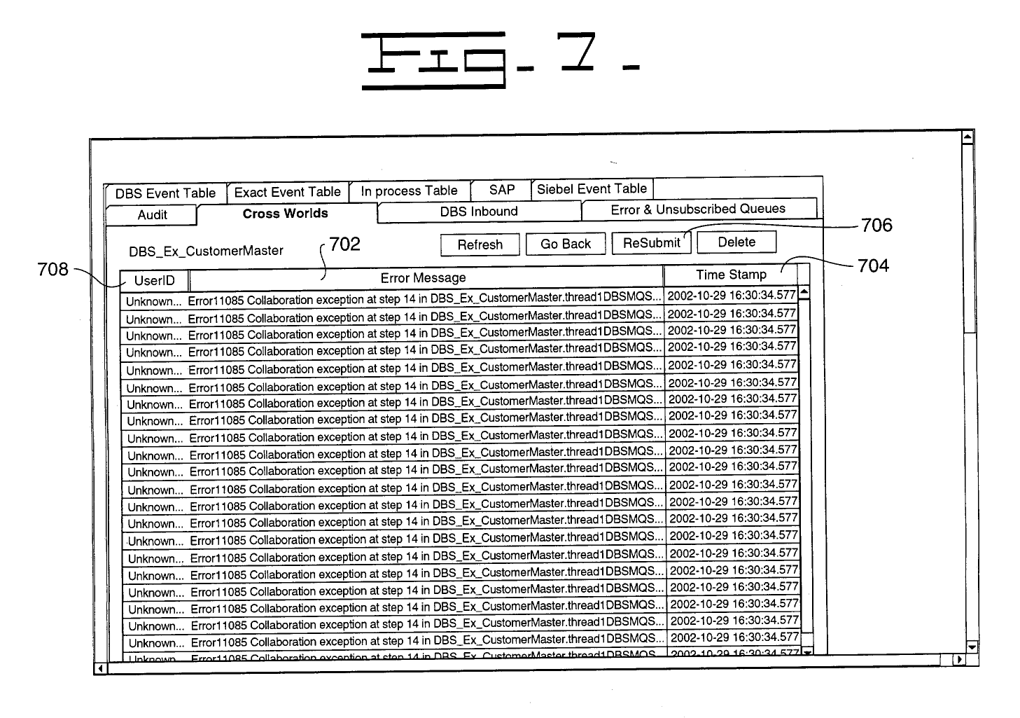

Therefore, the user may access the tab 508 associated with a particular vendor and/or application to detect whether a communication failure occurred. In addition, the user may establish additional information about the failure. For example, if the user activates the collaboration DBS_Ex_CustomerMaster 514, the user may view a list of the failure types associated with this particular type of communication failure. In this example, there were 23 failures associated with a failure of type: Error11085 602, as illustrated in FIG. 6. The user may activate Error11085 602, to see additional information regarding each of the associated errors, as illustrated FIG. 7. The user may view the actual error message 702, the time of the error 704, and the user associated with the error 708. In this manner the user may determine the cause of the error. For example, was the error a technical error, and if so, the user may determine what portion of the system 102 caused the error and whether the problem been resolved. Alternatively, the facilitation system 114 may automatically determine this. The user may determine if the error was a data or data structure based failure. In which case the user may fix the data or data structure associated with the error. In one embodiment, the user may drill down to see the data and/or data structures associated with the communication. The user may view the data and/or data structures associated with the first application 104 and the expected data/data structures associated with the second application 108, thereby enabling the user to establish the action needed to correct the failure.

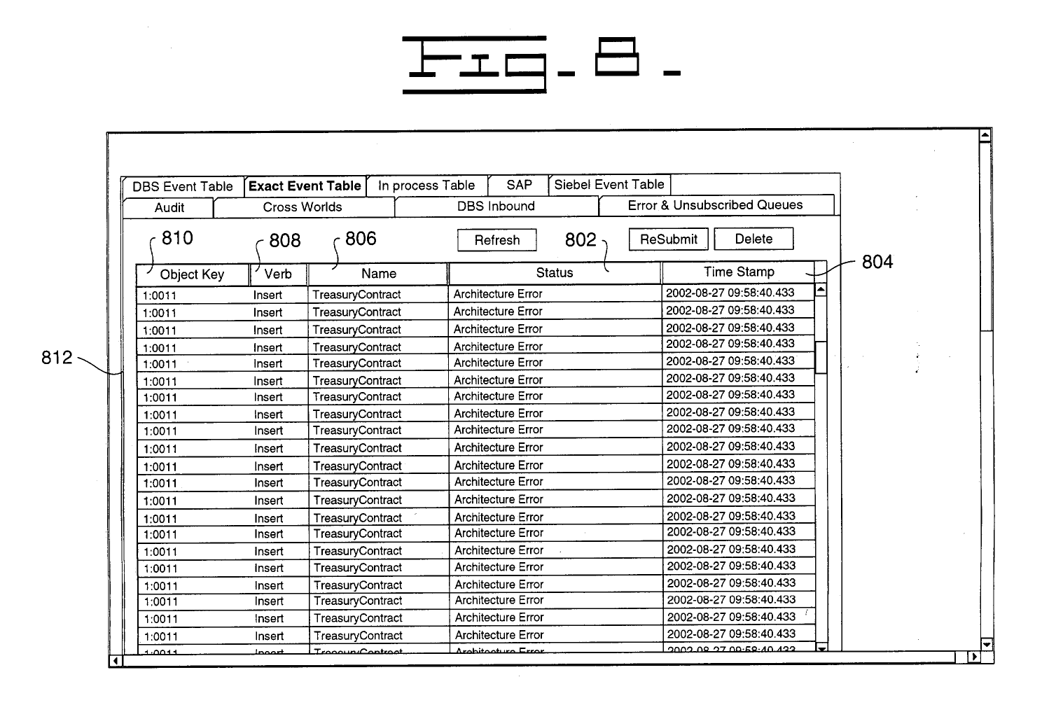

In any case, the user may then cause the message to be retransmitted by selecting the re-submit button 706. The re-submit button 706 places the message back in the communication queue 412 for retransmission. As mentioned above, the manner in which a communication is retransmitted is implementation and/or application dependent. FIG. 8 illustrates another exemplary display 812 of communication failures associated with the system 102, and in particular failures with the application Exact. The display 812 includes the name of the Exact function 806 attempting to send the communication, the time 804 the communication failure occurred, and the status 802, or cause of the failure. The object key and verb, are implementation dependent and simply refer to the movement of transactions through the conduit 108, and the type of action to be taken by the receiving application upon receipt of the communication. In this example, the communication failures are due to a technical problem, e.g., architecture error. In this example, the user may attempt to have the communications resubmitted for transmission, or may wait until verification is obtained that the architecture error has been resolved.

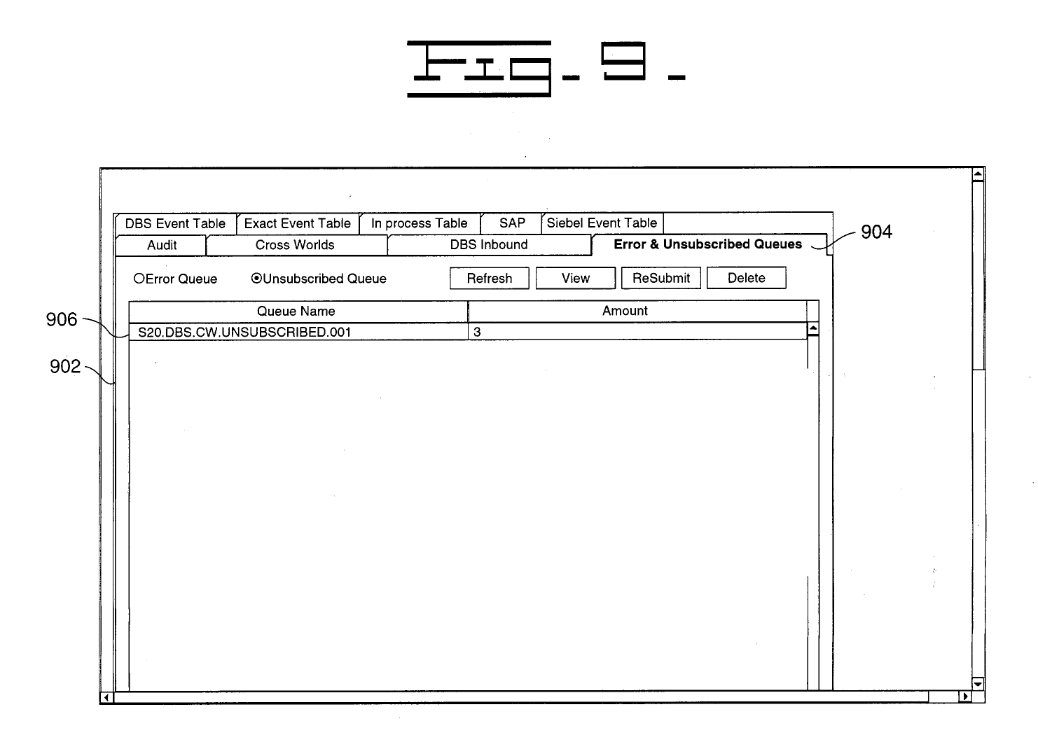

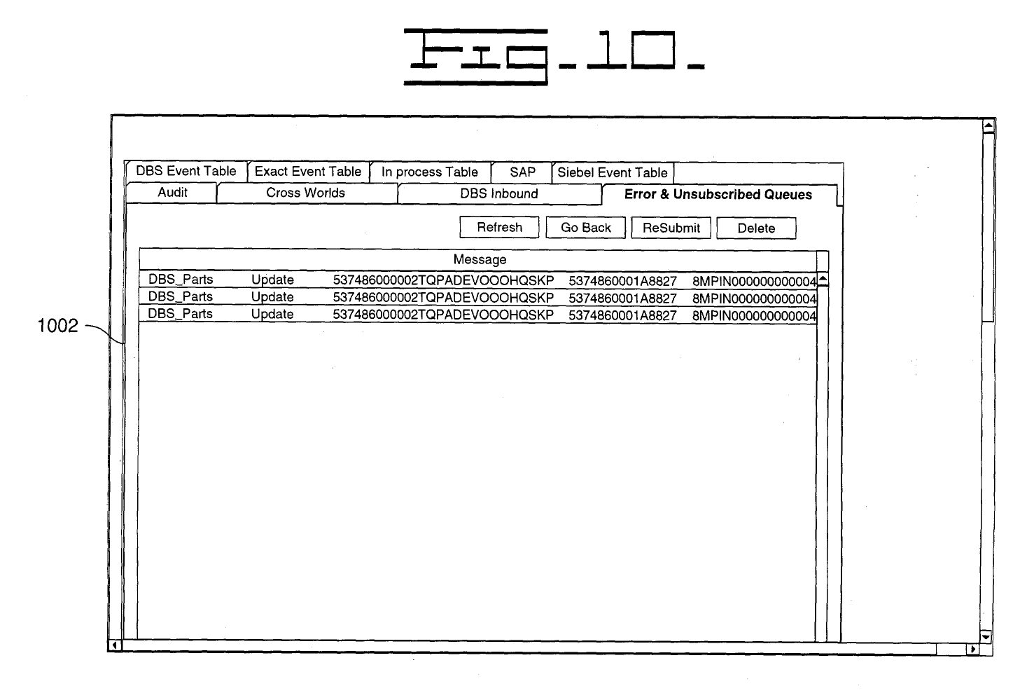

FIG. 9 illustrates an interface 902 associated with error and unsubscribed queues 904. Error and unsubscribed queues are associated with errors that where not able to be identified. For example, if a communication is received and the communication conduit 108 doesn't have appropriate information regarding where to deliver the communication then it may go into an unsubscribed queue. If one of the entries (e.g., S20.DBS.CW.UNSUBSCRIBED.001) is selected, then additional information regarding the error will be displayed in the interface 1002, as illustrated in FIG. 10.

In one embodiment, the facilitation system 114 may provide the user the ability to directly modify the data associated with a communication. For example, upon receiving a request to modify data associated with a data structure, e.g., the data structure associated with the failed application, the facilitation system 114 may access the data structure and interactively display it to the user to enable the user to modify the data. For example, the user may drill down into a category 402 to determine the cause of the problem was that the abbreviation of the state name was not entered correctly into a purchase order. The facilitation system 114 may include access to the data structure in the application. For example, the failed communication may include information, such as a data address, that would enable the facilitation system 114 to access the data (e.g., purchase order) and interactively display it to a user. Thereby, a user may modify the data, then activate the retransmit button, enabling the facilitation system 114 to store the modified data and/or data structure, and then cause the data to be retransmitted, e.g., modify the communication status on the event queue.

Other aspects, objects, and advantages of the present invention can be obtained from a study of the drawings, the disclosure, and the claims.

What is claimed is:

1. A method of communicating in a computing system having multiple applications communicating through a software communication conduit, comprising the steps of:
establishing a communication from a first application intended for a second application failed;
establishing a cause of said failed communication; and
causing said communication to be re-transmitted from said first application.

2. A method, as set forth in claim 1, wherein said first and second applications are of different types.

3. A method, as set forth in claim 1, wherein said first and second applications are of different vendors.

4. A method, as set forth in claim 1, further comprising the step of categorizing said failure based on at least one failure type, application type, content type, and location type, in response to said established cause.

5. A method, as set forth in claim 1, further comprising the step of modifying data associated with said communication in response to said failure cause.

6. A method, as set forth in claim 5, wherein the step of modifying said data further comprises the steps of:
establishing a first data structure associated with said first application;
establishing a second data structure associated with said second application; and
modifying said data associated in response to said first data structure and said second data structure.

7. A method, as set forth in claim 6, wherein said data modification includes modifying data included in said first application.

8. A method, as set forth in claim 1, wherein the step of causing said communication to be re-transmitted, includes the step of automatically resending said communication from said first application.

9. A method, as set forth in claim 8, wherein the step of causing said communication to be re-transmitted, includes the step of modifying a status of said communication.

10. A method, as set forth in claim 9, wherein said status includes one of a pending, a failed, and a complete status.

11. A method, as set forth in claim 8, wherein the step of modifying status includes modifying said status in a communication queue.

12. A method, as set forth in claim 7, wherein the step of causing said communication to be re-transmitted, includes the step of modifying a status of said communication.

13. A facilitation system configured to facilitate communication in a computer system having multiple applications communicating through a software communication conduit, comprising:
a controller configured to establish a communication from a first application intended for a second application failed, establish a cause of said failed communication, categorize said failed communication, and retransmit said communication in response to a user request; and
a user interface configured to display one or more of said categories to said user, and receive a retransmit command from said user.

14. A facilitation system, as set forth in claim 13, wherein said user interface is further configured to enable said user to display additional information regarding said communication failure in response to a drill down request.

15. A facilitation system, as set forth in claim 13, wherein said controller is further configured to modify a communication status in communication queue in response to said retransmit command.

16. A facilitation system, as set forth in claim 13, wherein said controller is further configured to access a data associated with said failed communication, in response to a user request.

17. A facilitation system, as set forth in claim 16, wherein said user interface is configured to interactively display data associated with said failed communication, and enable said user to modify said data.
